(19) United States
(12) Patent Application Publication
(10) Pub. No.: US 2024/0052858 A1
(43) Pub. Date: Feb. 15, 2024

(54) Detection Device, Cylinder Barrel Unit, and Method for Detecting a Position of a Piston in a Cylinder Barrel

(71) Applicant: Robert Bosch GmbH, Stuttgart (DE)

(72) Inventors: Johannes Schwacke, Bad Orb (DE); Nicolas Englert, Lohr (DE)

(21) Appl. No.: 18/447,015

(22) Filed: Aug. 9, 2023

(30) Foreign Application Priority Data
Aug. 11, 2022 (DE) 10 2022 208 372.5

(51) Int. Cl. F15B 15/28; F15B 15/10

(52) U.S. Cl. CPC F15B 15/2838; F15B 15/10

(57) ABSTRACT

A detection device is for detecting a position of a piston in a cylinder barrel and/or for detecting a strain on the cylinder barrel. The cylinder barrel includes a strain gauge. The detection device includes a reading interface configured to read a strain gauge signal from the strain gauge and an evaluation unit configured to evaluate the position of the piston and/or the strain on the cylinder barrel using the strain gauge signal.

This application claims priority under 35 U.S.C. § 119 to patent application no. DE 10 2022 208 372.5, filed on Aug. 11, 2022 in Germany, the disclosure of which is incorporated herein by reference in its entirety.

The disclosure relates to a detection device, a cylinder barrel unit, and a method for detecting a position of a piston in a cylinder barrel.

### BACKGROUND

When operating hydraulic cylinders, it is often necessary to detect the position of the piston and feed it back to the control and/or regulation of the higher-level system. This position detection can be absolute, relative or only a detection of the end positions/switching points. In most applications, absolute position detection is preferred.

With this in mind, the object of the disclosure is to provide an improved detection device, an improved cylinder barrel unit, and an improved method for detecting a position of a piston in a cylinder barrel.

This object is achieved by a detection device, a cylinder barrel unit and a method for detecting a position of a piston in a cylinder barrel as disclosed herein.

### SUMMARY

The approach presented is based on the realization that a detection device be created which can enable simple and reliable position detection and/or strain detection of a piston in a cylinder barrel.

The approach presented herein creates a detection device for detecting a position of a piston in a cylinder barrel and/or for detecting a strain on the cylinder barrel. In this case, the cylinder barrel comprises a strain gauge. The detection device has a reading interface for reading in a strain gauge signal of the strain gauge and an evaluation unit for evaluating a position of the piston and/or the strain on the cylinder barrel using the strain gauge signal.

The strain gauge can be used to detect elongation and compression deformations. For example, the strain gauge can be bonded to the cylinder barrel and deform when a strain is applied to the cylinder barrel. The approach presented herein can also be understood as a determination of the piston position in hydraulic cylinders by detecting and evaluating the strain differences on the outer diameter of the cylinder barrel.

The cylinder barrel can comprise at least a second strain gauge arranged at a different position than the strain gauge. In this case, the reading interface can be designed to read at least a second strain gauge signal from the second strain gauge. The evaluation unit can be further designed for evaluating a position of the piston and/or the strain on the cylinder barrel using the second strain gauge signal. Advantageously, by using a second strain gauge, a reliable, faster and more accurate position of the piston and/or strain on the cylinder barrel can be made possible. A second strain gauge can be manufactured inexpensively and installed on the cylinder barrel.

The reading interface can be designed to read the first and second strain gauge signals from the strain gauge and the second strain gauge, which can be oriented in an identical measurement direction. The position of the piston can therefore be detected quickly and easily.

The cylinder barrel can have at least a third strain gauge arranged at a different position than the strain gauge and the second strain gauge. In this case, the reading interface can be designed to read at least a third strain gauge signal from the third strain gauge. The evaluation unit can be further designed to evaluate a position of the piston and/or the strain on the cylinder barrel using the third strain gauge signal. Advantageously, by using a third strain gauge, a reliable, faster and more accurate position of the piston and/or strain on the cylinder barrel can be enabled. A third strain gauge can be manufactured and installed at low cost. Measurement errors can be prevented or at least reduced by using multiple strain gauges.

The evaluation unit can be designed to determine a position of the piston between the strain gauge and the second strain gauge when the strain gauge indicates an elongation represented by the strain gauge signal that is different from a second elongation of the second strain gauge represented by the second strain gauge signal. Advantageously, the position of the piston can be determined quickly and reliably by means of a simple evaluation procedure.

The evaluation unit can be designed to evaluate a circumference and, additionally or alternatively, a cross-section of the cylinder barrel using the at least one strain gauge signal in order to determine the strain on the cylinder barrel. Advantageously, in this way a strain on the cylinder barrel can be determined quickly and with technically simple means, since this strain on the cylinder barrel is essentially caused by a deformation of the wall of the cylinder barrel.

A cylinder barrel unit having a cylinder tube comprising a strain gauge comprises an embodiment of a detection device referred to herein. Such an embodiment can also very efficiently achieve the advantages of the approach described herein.

The at least one strain gauge can be arranged on an outer wall of the cylinder barrel or, additionally or alternatively, the at least one strain gauge can depict an elongation of an outer wall of the cylinder barrel. The strain gauge can, e.g., be adhered to the outer wall. In this way, the strain gauge or gauges can be reliably attached to the outer wall of the cylinder barrel.

The cylinder barrel can comprise a first strain gauge at a first position and at least one second strain gauge at a second position different from the first position. Doing so enables reliable position detection of the piston.

The strain gauges can be arranged parallel to each other. The gauges can have the same dimensions.

A method for detecting a position of a piston in a cylinder barrel and, additionally or alternatively, detecting a strain on the cylinder barrel, whereby the cylinder barrel comprises a strain gauge, includes the following steps:
reading a strain gauge signal from the strain gauge; and
evaluating a position of the piston and/or the strain on the cylinder barrel using the strain gauge signal. Such an embodiment can also very efficiently achieve the advantages of the approach described herein.

Also advantageous is a computer program product or computer program having program code that can be stored on a machine-readable carrier or storage medium, e.g., a semiconductor memory, a hard disk memory, or an optical memory. When the program product or program is executed on a computer or device, the program product or program can be used to perform, implement, and/or control the method steps according to one of the embodiments described hereinabove.

### BRIEF DESCRIPTION OF THE DRAWINGS

The disclosure will be explained in more detail hereinafter by way of example with reference to the accompanying drawings. Shown are:

FIG. 1 an illustration of a cylinder barrel for an exemplary embodiment of a cylinder barrel unit;

FIG. 2 an illustration of a cylinder barrel for an exemplary embodiment of a cylinder barrel unit; and

FIG. 3 a partial representation of an exemplary embodiment of a detection device;

FIG. 4 a flowchart of an exemplary embodiment of a method for detecting a position of a piston in a cylinder barrel and/or for detecting a strain on the cylinder barrel.

### DETAILED DESCRIPTION

Identical or similar elements can be indicated by identical or similar reference signs in the following drawings. Further, the figures in the drawings, the description thereof, and the claims contain numerous features in combination. It is in this context clear to a skilled person that these features can also be considered individually, or they can be combined to form further combinations not explicitly described herein.

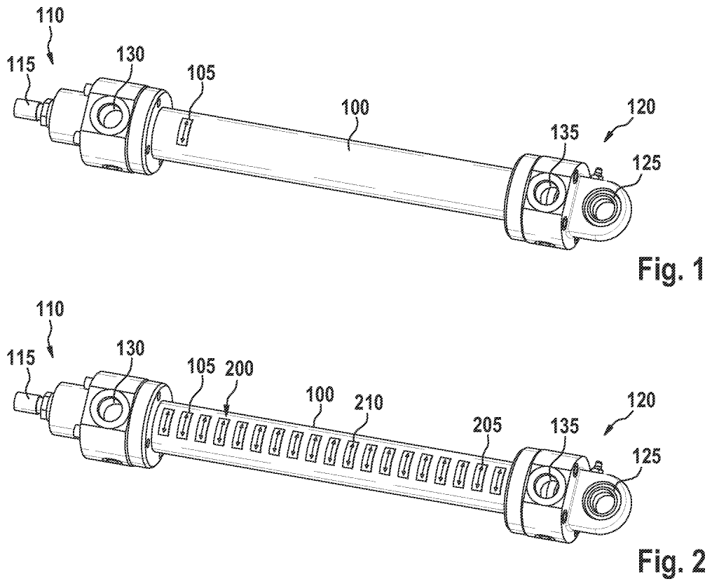

FIG. 1 shows an illustration of a cylinder barrel 100 for an exemplary embodiment of a cylinder barrel unit.

The cylinder barrel 100 comprises, e.g., a first fastener 115 at a first end 110 for fastening the cylinder barrel 100 to a piston. Also by way of example, a second fastener 125 is arranged at a second end 120 of the cylinder barrel 100 for fastening the cylinder barrel 100 to a piston. In this case, the second fastener 125 is, e.g., formed as a through-opening, e.g., in order to be able to guide a screw or a plug-in connection through it.

According to one exemplary embodiment, the cylinder barrel 100 comprises a first hydraulic port 130 at its first end 110 and a second hydraulic port 135 at its second end 120. The hydraulic ports 130, 135 are, e.g., similarly shaped and arranged parallel to each other and can be used to introduce and/or discharge a hydraulic fluid into the cylinder barrel 100.

The cylinder barrel 100 comprises a strain gauge 105 arranged, e.g., on an outer wall of the cylinder barrel 100. According to the exemplary embodiment shown herein, the strain gauge 105 is arranged in a region of the first end 110 of the cylinder barrel 100. The strain gauge 105 is, e.g., rectangular in shape and is bonded to the cylinder barrel 100.

When a strain is applied to the cylinder barrel 100, the strain gauge 105, e.g., deforms in order to depict an elongation of an outer wall of the cylinder barrel 100. According to one exemplary embodiment, the strain gauge 105 is sensitive on its surface in the direction of the double arrow shown, which exemplifies the directions in which elongation can occur and be measured.

FIG. 2 shows an illustration of a cylinder barrel 100 for an exemplary embodiment of a cylinder barrel unit. The cylinder barrel 100 in this case resembles or corresponds to the cylinder barrel shown in FIG. 1 except that the cylinder barrel 100 comprises a plurality of strain gauges 200.

According to the exemplary embodiment shown herein, the cylinder barrel 100 comprises a number of 19 strain gauges 200. Alternatively, the cylinder barrel can comprise a lower or higher number of strain gauges 200 as that shown in FIG. 2. The strain gauges 200 are, e.g., arranged parallel to each other and, e.g., have the same shape. According to the exemplary embodiment illustrated herein, a second strain gauge 205 is, e.g., arranged at a different position than the strain gauge 105.

According to one exemplary embodiment, a third strain gauge 210 is also arranged at a different position from the strain gauge 105 and the second strain gauge 205. For example, the third strain gauge 210 is arranged between the strain gauge 105 and the second strain gauge 205.

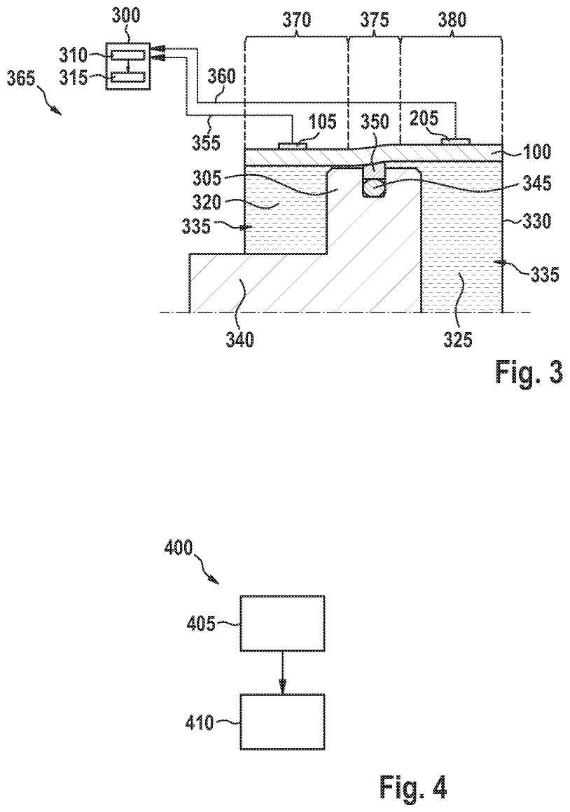

FIG. 3 shows a partial illustration of an exemplary embodiment of a detection device 300 in cross-sectional view. The detect device 300 is, e.g., arranged on a cylinder barrel 100. The cylinder barrel 100 can be the cylinder barrel 100 described in the preceding drawings. According to one exemplary embodiment, the cylinder barrel 100 comprises the first strain gauge 105 and at least the second strain gauge 205. The strain gauges 105, 205 are the same or similar to the strain gauges described in the preceding drawings.

The detection device 300 is designed to detect a position of a piston 305 in a cylinder barrel 100. Additionally or alternatively, the detection device 300 is designed to detect a strain on the cylinder barrel 100. The detection device 300 and the cylinder barrel 100 form a cylinder barrel unit 365.

The cylinder barrel unit 365 comprises for this purpose, e.g., the piston 305 arranged within a housing 330 and surrounded by a fluid 335. The piston 305 is arranged on a piston rod 340, in which case the piston 305 and the piston rod 340 are, e.g., integrally formed. The piston 305 comprises, e.g., a piston guide ring 345 and/or a piston seal 350. When the piston rod 340 moves translationally, the piston 305 moves translationally in the fluid 335 and causes a pressure 320, 325 on the fluid 335. According to the exemplary embodiment shown herein, the pressure 320 is smaller than the pressure 325. The cylinder barrel 100 is, e.g., arranged on the piston 305, the piston seal 350 being arranged between the cylinder barrel 100 and the piston 305. The piston 305 transmits the pressures 320, 325 to the fluid 335, exerting a radial strain or force on the cylinder barrel 100. The strain gauges 105, 205 on the cylinder barrel 100 detect this strain, which manifests itself as an elongation of the cylinder wall, and the strain gauges output strain gauge signals 355, 360 to the detection device 300.

In order to evaluate the strain gauge signals 355, 360, the detection device 300 comprises a reading interface 310 and an evaluation unit 315. The first strain gauge 105 outputs the first strain gauge signal 355 to the reading interface 310, and the second strain gauge 205 outputs the second strain gauge signal 360 to the reading interface 310. The reading interface 310 is designed to read the strain gauge signals 355, 360. Alternatively, the reading interface 310 is designed to read only one of the strain gauge signals 355, 360, or to read a third strain gauge signal in addition to the strain gauge signals 366, 360.

The evaluation unit 315 is designed to evaluate the position of the piston 305 and/or the strain on the cylinder barrel 100 using the strain gauge signals 355, 360. Alternatively, the evaluation unit 315 is designed to evaluate the position of the piston 305 and/or the strain on the cylinder barrel 100 using only one of the strain gauge signals 355, 360, or to evaluate the position of the piston 305 and/or the strain on the cylinder barrel 100 using an additional third strain gauge signal.

According to one exemplary embodiment, the evaluation unit 315 is designed to determine the position of the piston 305 between the strain gauge 105 and the second strain gauge 205. This is possible if, e.g., the strain gauge 205 indicates an elongation represented by the strain gauge signal 355. This elongation is then different from, e.g., a second elongation indicated by the second strain gauge 205 and represented by the second strain gauge signal 360. According to the exemplary embodiment illustrated herein, the second strain gauge 205 undergoes greater elongation than the first strain gauge 105.

According to one exemplary embodiment, the evaluation unit 315 is designed to evaluate a circumference and/or a cross-section of the cylinder barrel 100 using at least one of the strain gauge signals 355, 360 in order to determine the strain on the cylinder barrel 100.

The elongation of the cylinder barrel 100 due to internal pressures can be detected using a strain gauge 105, 205 in the circumferential direction on the outer diameter of the cylinder barrel 100. During operation, there is usually a pressure difference across the piston seal 350. As the piston 305, and thus the piston seal 350, is moved back and forth underneath the strain gauge 105, 205, the difference in strain, and thus passage of the piston 105, can be detected. By means of parallel placement of many strain gauges 105, 205 (see also FIG. 2) along the cylinder barrel 100, a better resolution is achieved. Furthermore, not only is a passage under the strain gauge 105, 205 detected, but also a more accurate position is detected since the elongation of the cylinder barrel 100 changes steadily rather than abruptly. Using this position detection solution, no special design of the cylinder is required. Instead, position detection can be retrofitted to compatible cylinders. Depending on the design of the system, an absolute determination of the internal pressures and therefore a force determination is also possible.

Most hydraulic cylinders have a 305 piston seal installed on the 305 piston. A pressure difference is normally present at this piston seal 305 during operation. The pressure difference is created by external forces that are overcome to move the piston 305 or even at standstill when holding the load. Even if no external force acts, the friction of the guide and sealing system must be overcome when the piston 305 moves and, depending on the size of the connection lines, a back pressure is formed by the outflowing hydraulic fluid. The internal hydraulic pressure acting in the cylinder expands the cylinder barrel 100. Given the two different pressure levels, e.g., three zones are formed: a first zone 370 with constant elongation at a low pressure level, a third zone 380 with constant elongation at a high pressure level, and a second zone 375 with the transition area between the two zones 370, 380. The piston seal 350 is ideally located centrally in the second zone 375. In addition to the internal pressure, the cylinder barrel 100 is also deformed by other effects, e.g., temperature changes or longitudinal or transverse forces. A strain gauge 105, 205 located on the outside of the cylinder barrel 100 measures the overall strain state of the cylinder barrel 100 at this location. With the aid of further sensor data and/or special software, the disturbance variables can be compensated to such an extent that a qualitative or quantitative evaluation of the strain state is possible.

In the qualitative evaluation, only the relative strain difference and thus the piston position is calculated. In the quantitative evaluation, the hydraulic pressure and thus the cylinder force can also be determined. Which of the two evaluation principles can be implemented depends strongly on the boundary and environmental conditions of the application.

The more strain gauges are placed, the better the resolution of the system and the more accurately the piston position can be determined. If only one strain gauge is used, then it can only function as a switch comparable to an inductive limit switch. The core of the approach presented herein is the position detection of hydraulic cylinders by means of external strain gauges.

FIG. 4 shows a flowchart of an exemplary embodiment of a method 400 for detecting a position of a piston in a cylinder barrel and additionally or alternatively detecting a strain on the cylinder barrel. The cylinder barrel in this case comprises a strain gauge. The method 400 comprises a step 405 for reading a strain gauge signal from the strain gauge. The method 400 further comprises a step 410 for evaluating a position of the piston and/or strain on the cylinder barrel using the strain gauge signal.

The exemplary embodiments shown are only selected by way of example and can be combined with each other.

### LIST OF REFERENCE SIGNS

100 Cylinder barrel
105 Strain gauges
110 First end
115 First fastener
120 Second end
125 Second fastener
130 First hydraulic port
135 Second hydraulic port
200 Plurality of strain gauges
205 Second strain gauge
210 Third strain gauge
300 Detection device
305 Piston
310 Reading interface
315 Evaluation unit
320 Pressure
325 Pressure
330 Housing
335 Fluid
340 Piston rod
345 Piston guide ring
350 Piston seal
355 First strain gauge signal
360 Second strain gauge signal
365 Cylinder barrel unit
370 First zone
375 Second zone
380 Third zone
400 Method for detecting a position of a piston in a cylinder barrel and/or for detecting a strain on the cylinder barrel
405 Reading step
410 Evaluation step

What is claimed is:

1. A detection device for detecting a position of a piston in a cylinder barrel and/or for detecting a strain on the cylinder barrel, the cylinder barrel comprises a strain gauge, the detection device comprising:
a reading interface configured to read a strain gauge signal from the strain gauge; and
an evaluation unit configured to evaluate the position of the piston and/or the strain on the cylinder barrel using the strain gauge signal.

2. The detection device according to claim 1, wherein:
the strain gauge is a first strain gauge,
the strain gauge signal is a first strain gauge signal,
the cylinder barrel comprises at least one second strain gauge arranged at a different position than the first strain gauge,
the reading interface is further configured to read at least one second strain gauge signal from the at least one second strain gauge, and
the evaluation unit is further configured to evaluate the position of the piston and/or the strain of the cylinder barrel further using the at least one second strain gauge signal.

3. The detection device according to claim 2, wherein:
the reading interface is further configured to read the first strain gauge signal from the first strain gauge and to read the at least one second strain gauge signal from the at least one second strain gauge, and
the first strain gauge and the at least one second strain gauge are in an identical measurement direction.

4. The detection device according to claim 2, wherein:
the cylinder barrel comprises at least one third strain gauge arranged at a different position than the first strain gauge and the at least one second strain gauge,
the reading interface is further configured to read at least one third strain gauge signal from the third strain gauge, and
the evaluation unit is further configured to evaluate the position of the piston and/or the strain of the cylinder barrel further using the at least one third strain gauge signal.

5. The detection device according to claim 2, wherein:
the evaluation unit is configured to determine the position of the piston between the first strain gauge and the at least one second strain gauge when the first strain gauge indicates an elongation represented by the first strain gauge signal that is different from a second elongation of the at least one second strain gauge represented by the at least one second strain gauge signal.

6. The detection device according to claim 1, wherein the evaluation unit is further configured to evaluate a circumference and/or a cross-section of the cylinder barrel using the strain gauge signal in order to determine the strain on the cylinder barrel.

7. A cylinder barrel unit comprising:
a cylinder barrel;
a piston located in the cylinder barrel;
at least one strain gauge operably connected to the cylinder barrel; and
a detection device operably connected to the at least one strain gauge, the detection device configured to detect a position of the piston in the cylinder barrel and/or to detect a strain on the cylinder barrel, the detection device comprising (i) a reading interface configured to read a strain gauge signal from the at least one strain gauge, and (ii) an evaluation unit configured to evaluate the position of the piston and/or the strain on the cylinder barrel using the strain gauge signal.

8. The cylinder barrel unit according to claim 7, wherein the at least one strain gauge is arranged on an outer wall of the cylinder barrel and/or the at least the one strain gauge is configured to detect and/or to depict an elongation of the outer wall.

9. The cylinder barrel unit according to claim 7, wherein the at least one strain gauge includes a first strain gauge at a first position and at least one second strain gauge at a second position different from the first position.

10. The cylinder barrel unit according to claim 9, wherein the first strain gauge and the at least one second strain gauge are arranged parallel to each other.

11. A method for detecting a position of a piston in a cylinder barrel and/or for detecting a strain on the cylinder barrel, the cylinder barrel comprising a strain gauge, the method comprising:
reading a strain gauge signal from the strain gauge; and
evaluating the position of the piston and/or the strain on the cylinder barrel using the strain gauge signal.

12. The method according to claim 11, wherein a computer program product comprises program code configured to perform the method when the computer program product is executed on a device.

13. The method according to claim 12, wherein the computer program product is stored on a non-transitory machine-readable storage medium.
